(19) United States
(12) Patent Application Publication
(10) Pub. No.: US 2012/0187897 A1
(43) Pub. Date: Jul. 26, 2012

(54) BATTERY CHARGER FOR USE WITH LOW VOLTAGE ENERGY HARVESTING DEVICE

(75) Inventors: KENNETH LAWRENCE LENK, Mountain View, CA (US); ANTONINO SOFIA, Munich (DE)

(73) Assignee: INTERSIL AMERICAS INC., Milpitas, CA (US)

(21) Appl. No.: 13/341,338

(22) Filed: Dec. 30, 2011

Related U.S. Application Data
(60) Provisional application No. 61/435,653, filed on Jan. 24, 2011.
(60) Provisional application No. 61/559,881, filed on Nov. 15, 2011.

(51) Int. Cl. H02J 7/00

(52) U.S. Cl. 320/101

(57) ABSTRACT

A battery charging integrated circuit includes a first input connected to an energy harvesting device and a first output providing charging voltage to a battery. Control circuitry charges the battery through the first output responsive to an input from the energy harvesting device. The battery charging integrated circuit is powered by the battery connected to the first output.

### CROSS-REFERENCE TO RELATED APPLICATIONS

This application claims priority from U.S. Provisional Application No. 61/559,881, entitled POWER BATTERY CHARGER FOR USE WITH LOW VOLTAGE SOLAR CELL, filed Nov. 15, 2011, and from U.S. Provisional Application No. 61/435,653, entitled LOW VOLTAGE SOLAR CELL POWER BATTERY CHARGER, filed Jan. 24, 2011.

### BRIEF DESCRIPTION OF THE DRAWINGS

For a more complete understanding, reference is now made to the following description taken in conjunction with the accompanying Drawings in which:

FIG. 1 is a block diagram of one embodiment of a powered battery charger for use with a low voltage energy harvesting device;

FIG. 2 is a block diagram of one embodiment of a powered battery charger with a low voltage solar cell;

FIG. 3 illustrates a more detailed diagram of the battery charger with multiple selectable sources;

FIG. 4 is a detailed schematic diagram of one embodiment of the powered battery charger of FIG. 2;

FIG. 5 illustrates an alternative embodiment of the charger of FIG. 2;

FIG. 6 illustrates an electronic/electric system including circuitry including the charging circuitry of FIGS. 1-4 according to one embodiment;

FIG. 7 illustrates a simplified diagram of the boost regulator;

FIG. 8 illustrates a timing diagram for the boost regulator of FIG. 7;

FIG. 9 illustrates a flow chart of the operation of the boost regulator;

FIGS. 10-14 illustrate a flow chart of the operation of the embodiment of FIG. 5;

FIGS. 15 and 16 illustrate two alternative embodiments of the implementation of the battery charger on an integrated circuit;

FIGS. 17 and 18 illustrate a diagrammatic views of powered devices with an on-board CPU;

FIG. 19 illustrates a diagrammatic view of a self-contained powered unit; and

FIG. 20 illustrates a diagrammatic view of a hand-held device utilizing a plurality of harvesting devices.

### DETAILED DESCRIPTION

Referring now to the drawings, wherein like reference numbers are used herein to designate like elements throughout, the various views and embodiments of a power battery charger for use with a low voltage solar cell are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

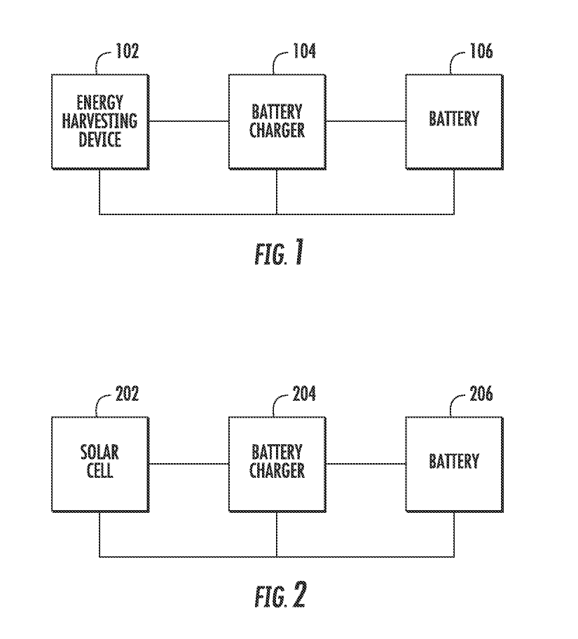

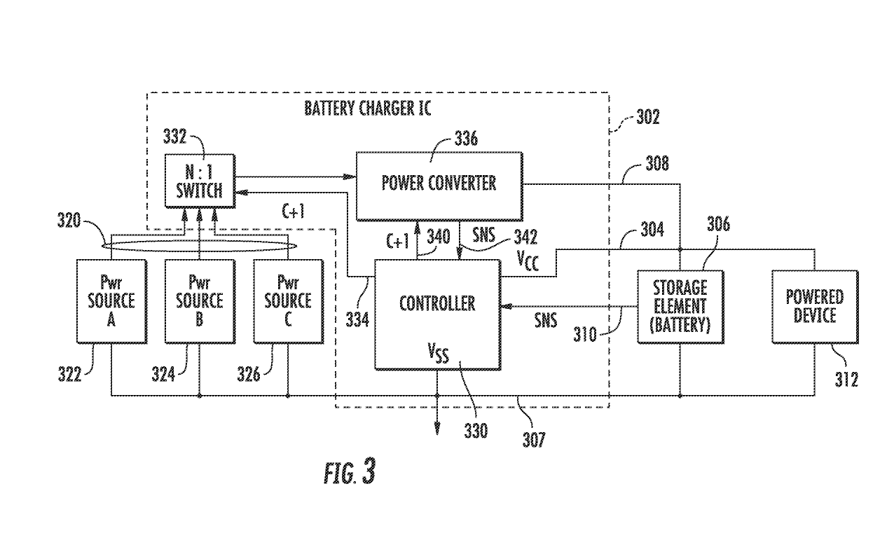

Referring now to FIGS. 1 and 2, there is illustrated a block diagram of a configuration of an energy harvesting device 102 connected with a battery charger 104 and a battery 106 and also for a solar cell 202 charging a battery 206 using a battery charger 204, this being the “core” of the overall charging operation. In FIG. 1, the battery charger 104 is powered by the connected battery 106 that is being charged by the battery charger 104. In a disclosed embodiment, the battery 106 comprises a lithium ion battery. The use of the battery voltage from the battery 106 enables the battery charger 104 to be powered from a reliable source of power such that a sufficient operating voltage can be maintained.

A single solar cell output voltage such as that illustrated in FIG. 2 is insufficient to run standard CMOS processes within the battery charger 204. By powering the battery charger 104 using the associated battery 106, the battery charger 104 can be developed using standard CMOS processes since the battery will provide a 2.5 volts minimum voltage (other voltage levels may be used) from which to operate. In addition to the solar cell 202 illustrated in FIG. 2, the energy harvesting device 102 can comprise other types of devices such as a thermo electric device, a low power source such as inductive coupling or piezoelectric device, etc. The configuration will be the same as that described with respect to FIGS. 1 and 2 wherein the battery charger 104 is powered by the battery 106 rather than the energy harvesting device of any particular type such that the energy harvesting device can have a voltage less than the battery charger 204 operating voltage, and wherein the lowest voltage of the energy harvesting device is less than the operating voltage. The energy harvesting device 102 is a device that is a renewable energy device and outputs a “discontinuous” voltage due to, for example, the lack of sunlight for a solar cell.

The energy harvesting device 102/solar cell 202 generates the charging energy responsive to an input, for example the receipt of solar energy, and provides this to the battery charger 104/204. The battery charger 104/204 converts the received charging energy into a charging signal that is provided to the battery 106/206. The battery 106/206, in addition to powering an associated electronic device, powers the battery charger 104.

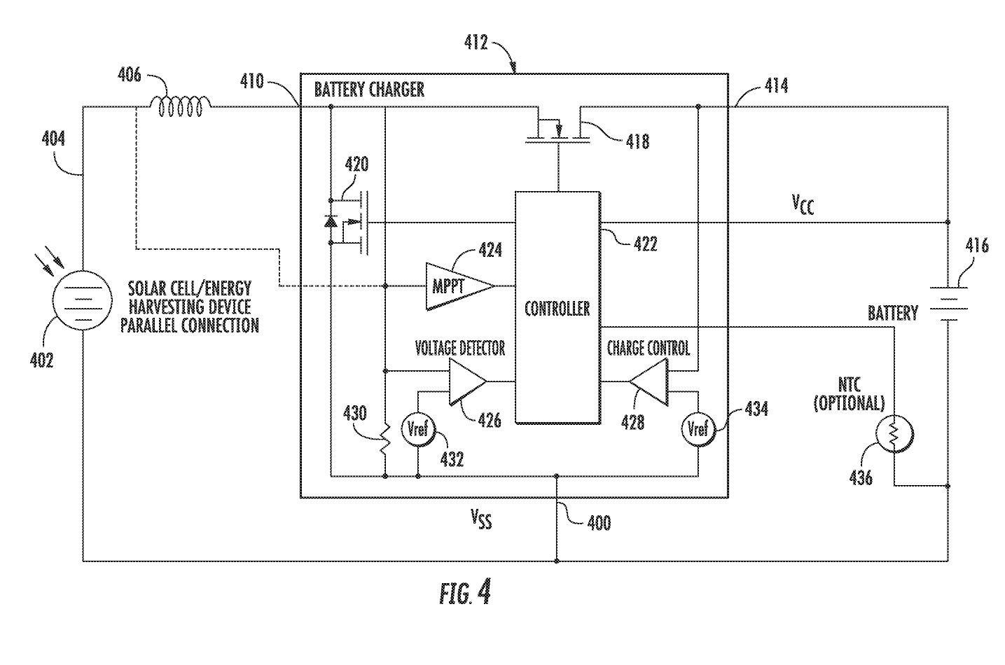

Referring further to the drawings, and more particularly to FIG. 3, there is illustrated a more detailed diagrammatic view of a diagram illustrated in FIGS. 1 and 2. In FIG. 3, the battery charger is generally illustrated by a battery charger integrated circuit (IC) 302 corresponding to the battery charger 104/204 of FIGS. 1 and 2. In this embodiment, the battery charger is realized on a monolithic integrated circuit. The battery charger is comprised of a VCC or storage element input node 304 for receiving power from a storage element or battery 306, corresponding to battery 106/206 in FIGS. 1 and 2. The battery charger 302 provides a charging output on a line 308 to provide a charge transfer output to the battery 306. There is also provided a sense input on a line 310 for receiving parameters regarding the operation of the battery 306. This could be temperature parameters of the battery, current driven to the battery, voltage level of the battery, etc. The battery 306 also delivers power to a powered device 312 within this embodiment. It should be understood that the battery charger IC 302 could be a stand alone charger merely for charging the battery 306.

Battery 306 is a device that operates over a voltage range from a minimum value to a maximum value at full charge. Below a minimum voltage value, it is not safe to either operate the battery or to even charge the battery. However, at the minimum battery voltage level, the battery will deliver a sufficient voltage level to provide a VCC voltage level to the battery charger IC 302 to power the battery charger IC 302 operating under minimum operating constraints. The battery charger IC 302 has a plurality of external power source inputs 320, each for receiving power from respective power sources 322, 324 and 326, it being understood that there could be one source only or multiple sources. At least one of the sources, if not all three, is a low voltage energy harvesting device such as a solar cell, a piezoelectric device, etc. The voltage output by this at least one low voltage source is insufficient to power the battery charger IC 302 and, therefore, the primary power for at least the start-up power for the battery charger IC 302 is received from the battery 306.

Battery charger IC 302 operates as a battery charge core that provides all the necessary operations to transfer charge from a power source to the battery in a controlled manner and contains as an integral part thereof a charge control section including a battery charge controller 330 which is operable to be powered by the VCC input and is operable to perform various control functions. This battery charge controller 330 can be realized with combinatorial logic or it could be realized with a microcontroller or processor. The power output from a selected one of the power sources 322-326 is selected by a switch 332 which is controlled by the battery charge controller 330 via a control line 334. Even though each of the power sources 322-326 are illustrated as having a separate pin for the battery charger IC 302, it could be that the switch 332 would be implemented external and the control line would be output in the form of the control line 334. A power converter 336 is provided within the battery charger IC 302 in order to receive the output of the switch 332 and transfer charge to the battery 306. In order to facilitate this conversion/charge operation, the power converter 336 would ensure that the input voltage, in the case of a low voltage harvesting device such as a solar cell, was converted to a higher voltage than the voltage of the storage element/battery in order to transfer charge to the storage element/battery 306 or, in the case of a power source with a voltage higher than the voltage of the storage element/battery 306, to regulate that power to a voltage adequate to charge the storage element/battery 306, as described hereinbelow.

The battery charge controller 330 operates in multiple charging modes. The battery charge controller 330 is initially powered up by the storage element/battery 306, when it is attached between VCC on input node 304 and VSS on node 307 and then the battery charge controller 330 initially goes into a mode to ensure the storage element/battery 306 is in a safe operating mode and then into a mode which is operable to detect the presence of one or more of the various charging sources. If no charging sources are available, the battery charge controller 330 is maintained in a low power or sleep mode until such power source is detected. Once the power source is detected, a determination can be made as to what type of source exists and how the power converter 336 is to be controlled. The battery charge controller 330 controls the power converter via a control line 340 and receives feedback information from the power converter 336 via a line 342. Once a determination has been made that the power source is attached and that power can now be transferred to the storage element, the battery charge controller 330 is powered up to a control mode wherein the power converter 336 is then controlled to transfer charge to the storage element/battery 306. This operation is monitored and, when the storage element/battery is at a fully charged level, the battery charge controller 330 will discontinue the charging operation and go back into a sleep mode until it is necessary to again charge the storage element/battery.

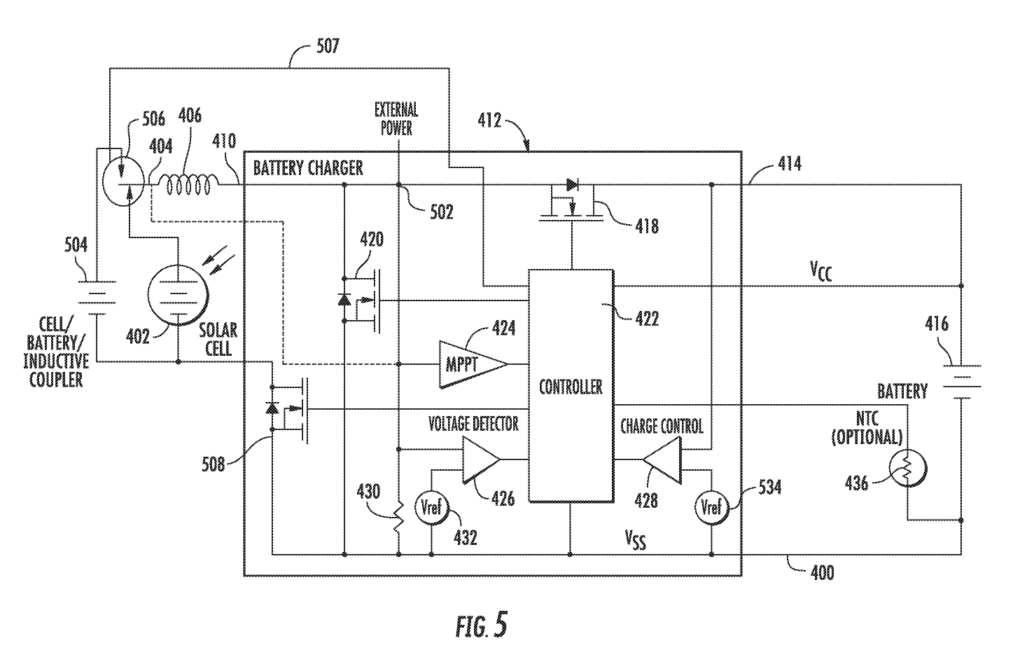

Referring further to the drawings, and more particularly to FIG. 4, there is more particularly illustrated an implementation of a battery solar charger circuit such as that illustrated with respect to FIGS. 2 and 3. While the following embodiment is described with respect to a lithium ion battery 416 and a solar cell/energy harvesting device 402, one skilled in the art will realize that many types of batteries 416 may be utilized in the implementation and many other different types of low voltage energy harvesting devices such as those described hereinabove may also be utilized. A solar cell/energy harvesting device 402 is connected between node 404 and reference node 400, e.g., ground potential. The solar cells 402 may include a single cell or a parallel connection of a number of cells. The parallel configuration enables a more useful output with no single cell outage versus a series connection. An external inductor 406 is connected between node 404 and a first input node 410 of a battery charger 412. The battery charger 412 has an output node 414 provided to one terminal of the lithium ion battery 416. The lithium ion battery 416 is connected between the output node 414 and reference node 400. A connection is provided between the input voltage created by the solar cell 402 provided through inductor 406 to the input of battery charger 412 at input node 410 and the output voltage provided at output node 414 to the lithium ion battery 416 through an n-channel MOS switching transistor 418. Switching transistor 418 has its source/drain path connected between input node 410 and output node 414. A second n-channel MOS switching transistor 420 has its source/drain path connected between input node 410 and node 400, which is the V_{SS} connection of the battery charger 412. The gates of each transistor 418 and 420 are connected to receive control signals from a controller 422. The transistors 418 and 420 in conjunction with the inductor 406 provide a synchronous voltage boost circuit.

The controller 422 receives control signal inputs from a maximum power point transfer circuit 424 (MPPT), a voltage detector 426 and a charge control circuit 428. The input of the maximum power point transfer circuit 424 is connected to the input node 410 and its output is connected to the controller 422. The maximum power point transfer circuit 424 comprises a feed forward circuit for controlling the maximum charging power of the battery 416 when a solar cell comprises the energy harvesting device. The maximum power point transfer circuit 424 provides for high efficiency hysteretic control of the charging process. The maximum power point transfer circuit 424 may also optionally be connected to directly measure the open cell voltage level of the energy harvesting device (solar cell 402) rather than through an indirect connection (which may include an error). The maximum power point transfer circuit 424 monitors for the occurrence of a predetermined maximum power point level from the solar cell and generates an output to the controller 422 when this is detected. The voltage detector 426 has its output connected to the controller 422 and one input connected to the input node 410. A resistor 430 is connected between input node 410 at the input of the voltage detector 426 and the reference node 400. The other input of the power detector 426 is connected to receive a reference voltage 432 (V_{REF}). The voltage detector 426 compares the input voltage at input node 410 with the reference voltage 432 to determine the provided input voltage to the battery charger 412 and provide a control signal to the controller 422 responsive thereto. As will be described hereinbelow, this voltage detector 426 is able to detect multiple voltages and discriminate therebetween. Finally, the charge control circuit 428 has its output connected to the controller 422 and one input connected to the output node 414. The other voltage input of the charge control circuit 428 is connected to a reference voltage 434 V_{REF}. The charge control circuit 428 compares the voltage at output node 414 with the reference voltage 434 to, in one mode, determine the charge level of the lithium ion battery 316 and generate a control signal responsive thereto to the controller 422. In another mode, the charge control is used as a voltage detector to determine if the battery 416 is within a safe operating range for charging.

The controller 422 of FIG. 4 provides various modes of operation for the battery charger 412 responsive to the control signals from each of the MPPT 324, voltage detector 426, charge controller 422 and charge control circuit 428 These include a dark (sleep) mode of operation and active modes of operation. These modes provide battery protection for the connected battery 416 by providing an over voltage shut-off and inhibiting charging outside of a selected temperature range. In the dark mode of operation, the battery charger 412 provides an ultra low quiescent that will minimize self discharge within the battery 416 and provide a maximum battery standby life. Within the dark mode of operation, the controller 422 monitors the power input to the battery charger 412 using the power detector 426 to determine if adequate power is present to start-up the battery charger 412. The charging operation of the battery charger 412 is disabled if the power provided from the solar cell 402 is less than a required minimum operating level defined by the reference voltage V_{REF} 432.

In the embodiment shown in FIG. 4, the battery charger 412 has different charging modes. When the battery charger 412 is in an active charge mode of operation, the battery charger 412 controls the operation of transistors 418 and 420 to provide a synchronous boost charging of the battery 416 via power provided from the solar cell 402 that is close to the maximum power point transfer of the solar cell as determined by the MPPT circuit 424. The controller 422 controls the operation of the transistor 418 to maintain the power provided to the battery 416 close to the maximum power point transfer level.

The active standby mode of operation of the battery charger 412 comprises a “do nothing” function when the battery 416 achieves a charge threshold (approximately 85% SOC) as determined by the charge control circuit 428. In the active standby mode, charging is inhibited by the controller 422. The standby mode may also disable charging of the battery 416 if the external NTC 436 senses temperatures outside of the battery operating range (typically 0° C. <battery<50° C.). The NTC 436, which is optional, provides a signal to the charge controller 422 responsive to the sensed temperature.

The ultra low quiescent current will minimize self discharge within the battery 416 and provide a maximum battery standby life. The parallel configuration enables the use of lower cost, high output parallel solar cells 402. The parallel configuration enables a more useful output with no single cell outage versus a series connection. The battery charger 412 provides over voltage shut down wherein the controller 422 regulates the charging to a charge termination voltage (in one embodiment 4.15 volts). The controller 422 regulates the “on” voltage of the transistor 420 in the synchronous boost operation and charges via inductor current pulsing by controlling the operation of transistors 418 and 420. An optional internal over voltage clamp clamps battery voltage to 4.3 volts for safety. Ideally, a simple Zener clamp structure may be used. The battery charger 412 also provides an under voltage lock out that inhibits operations less than 2.8 volts for safety via the charge control circuit 428, which provides a voltage comparator that compares the battery voltage against a voltage reference value provided by the voltage reference 434. The battery 416 can be hazardous if charged at this level, assuming a single cell Li Ion battery. The battery charger 412 provides charge temperature control that inhibits lithium ion charging at less than 0° C. or greater than 50° C. to avoid damage to the battery responsive to control signals from the NTC 436. While the above discussion relates to a lithium cobalt battery, the invention is applicable to any lithium or other battery chemistry/voltage.

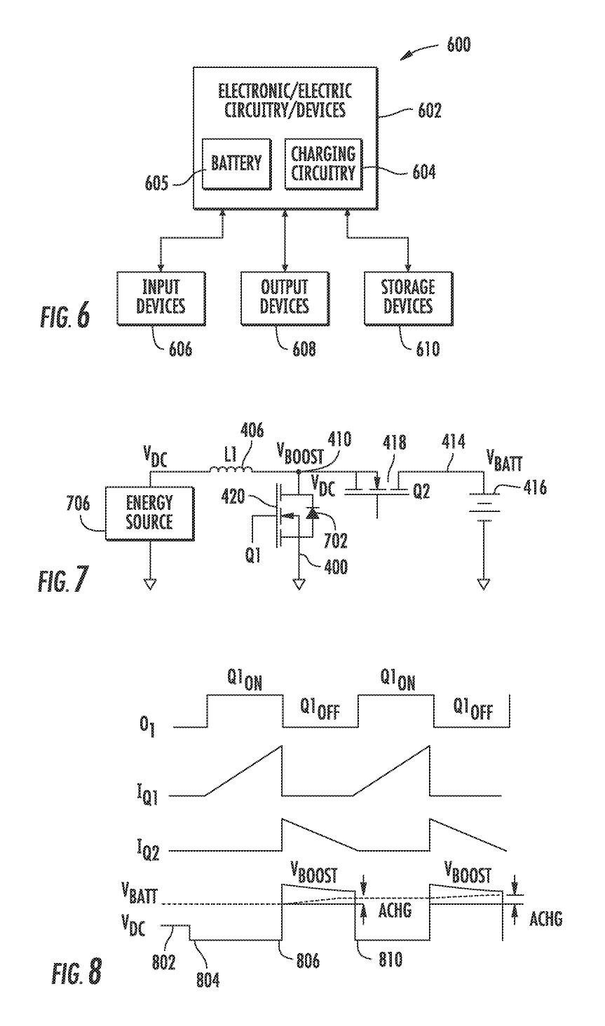

An alternative embodiment is illustrated in FIG. 5. The main difference between the embodiments of FIG. 4 and FIG. 5 is the addition of a USB/AC adapter/external power charging input at node 502, which is a high voltage power source as compared to the low voltage power source such as solar cells, piezoelectric devices, etc. Additionally, the embodiment provides for the inclusion of other low voltage (below the battery voltage (V_{BAT})) power sources such as the addition of a battery cell/battery/inductive coupler 504. Other types of low voltage sources such as a thermoelectric source, etc. may also be used as additional power sources for charging the battery. The battery cell/battery/inductive coupler 504 does not have to be provided with the external power charging input at node 502. If an inductive coupler is used, the coupler may comprise inductive coupling circuitry for connecting an external battery or cell to the circuit.

The solar cell 402 is connected between node 404 and reference node 400. The solar cells 402 may include a single cell or a parallel connection of a number of cells. The inductor 406 is connected between node 404 and a first input node 410 of the battery charger 412. The node 404 is selectably connected to either one node of the solar cell 402 or one node of the cell/battery/inductive coupler 504 through a switch 506 controlled by a signal on line 507 from controller 422. The battery charger 412 has an output node 414 provided as an output to one terminal of the lithium ion battery 416. The lithium ion battery 416 is connected between the output node 414 through switch 506 and inductor 406 and reference node 400 through the source drain path of a transistor 508. When selected, a connection is provided between the input voltage created by the solar cell 402 provided to the input of battery charger 412 at input node 410 and the output voltage provided at output node 414 to the lithium ion battery 416 through the switching transistor 418. Switching transistor 418 has its source/drain path connected between input node 410 and output node 414. The second switching transistor 420 has its source/drain path connected between input node 410 and node 400. The gates of each transistors 418 and 420 are connected to receive control signals from a controller 422.

The controller 422 receives control signal inputs from a maximum power point transfer circuit 424 (MPPT), a voltage detector 426 and the charge control circuit 428. The input of the maximum power point transfer circuit 424 is connected to the input node 410 and its output is connected to the controller 422. The maximum power point transfer circuit 424 comprises a feed forward circuit for controlling the maximum charging power of the battery 416. The maximum power point transfer circuit provides for high efficiency hysteretic control of the charging process. The maximum power point transfer circuit 424 may also optionally be connected to directly measure the open cell voltage level of the energy harvesting device rather than through an indirect connection (which may include an error). The maximum power point transfer circuit 424 monitors for the occurrence of a predetermined maximum power level from the solar cell and generates an output to the controller 422 when this is detected. The voltage detector 426 has its output connected to the controller 422 and one input connected to the input node 410. A resistor 430 is connected between input node 410 at the input of the voltage detector 426 and the reference node 400. The other input of the reference detector 426 is connected to receive a reference voltage 432 (V_{REF}). The voltage detector 426 compares the input voltage at input node 410 with the reference voltage 432 to determine the provided input voltage to the battery charger 412 and provide a control signal to the controller 422 responsive thereto. Finally, the charge control circuit 428 has its output connected to the controller 422 and one input connected to the output node 414. The other voltage input of the charge control circuit 428 is connected to a reference voltage 434 V_{REF}. The charge control circuit 428 compares the voltage at output node 414 with the references voltage 434 to determine the charge level of the lithium ion battery 416 and generate a control signal responsive thereto to the controller 422.

The battery charger 412 provides over voltage shut down wherein the controller 422 regulates the charging voltage to 4.15 volts (other voltage levels may be used) responsive to the control signal from the charge controller 422. The controller 422 regulates the “on” voltage of the transistor 420 in a synchronous boost operation to charge the inductor 406 and then transfer stored charge to the battery 416. An optional internal over voltage clamp clamps the battery voltage to 4.3 volts for safety. Ideally, a simple Zener clamp structure may be used. The battery charger 412 also provides an under voltage lock that inhibits operations less than 2.8 volts for safety, wherein the charging circuitry is configured as a comparator for comparing the battery voltage V_{BAT} with a reference voltage generated by the voltage reference 434. The battery 416 can be hazardous if charged at this level. The battery charger 412 provides charge temperature control that inhibits lithium ion charging less than a minimum charging temperature (in one embodiment 0° C.) or greater than a maximum charging temperature (in one embodiment 45° C. or 50° C.) to avoid damage to the battery.

An external USB/external power input connection node 502 is added to enable a USB or other type of external power connector to be connected with the battery charger 512, this being at voltage higher than the battery voltage, thus not requiring any voltage boost. Through the USB or external power source connection, the battery 416 may be charged using the USB or external power source. By integrating a USB connector at node 502 with a solar charging circuit in one device, the solar efficiency of the circuit is maximized due to direct power transfer. When the controller 422 detects connection of a USB or external power source at node 502, the transistor 508 connected between reference node 400 and the low voltage sides of both the solar cell 402 and the cell/battery/inductive coupler 504 is turned off to disconnect the solar cell 402 or the cell/battery/inductive coupler 504 from the battery charger 412. The controller 422 detects the USB connection with voltage detector 426. The circuit additionally eliminates the conversion/charging stages of the synchronous boost operation when the USB external power source connection is utilized via the transistor 418 operated in a constant current/constant voltage mode, as will be described in more detail hereinbelow. The design is easily implemented since USB chargers are used in many portable devices. The gate of transistor 508 is connected to the controller 522 to connect and disconnect the solar cell 402 and battery 504 when a high power source is connected via the USB/external power input connection 502.

The switch 506 enables connection of either a battery or cell 504, e.g. an AA battery, or the solar cell 402 to the input of the battery charger 512 through the inductor 406. This configuration enables a single part having three or more charging options using either the low voltage battery/cell 504, the low voltage solar cell 402 or the high power USB or a high power external power source at connector 502. This would enable the associated portable device to extend its run time by connecting one of the alternative power sources such that a user would be able to complete, for example, watching a movie on a mobile media telephone if the battery charge drops too low.

The above described implementations provide a number of benefits to a battery charger for a power harvesting device. The use of a battery voltage to power the battery charger simplifies the circuit design in complexity by providing a smaller, lower cost IC. The configuration allows for normal IC processes that do not need low threshold voltage devices and require lower wafer cost. The configuration also provides higher solar energy efficiency by improving gate to source voltages. The integration of the USB and solar charging along with a battery backup into a single device maximizes solar efficiencies due to direct power transfer. The implementation eliminates additional conversion/charging stages and allows for the removal of redundant circuitry. The integration of the USB and solar charging into a single device permits faster design since a USB charger is used in many portable devices today. The flexibility of additional low power input to accommodate additional power sources such as AA batteries or inductive coupling enables a single part to allow for three or more charging options at a low cost and extends the run time that is associated with electronic devices.

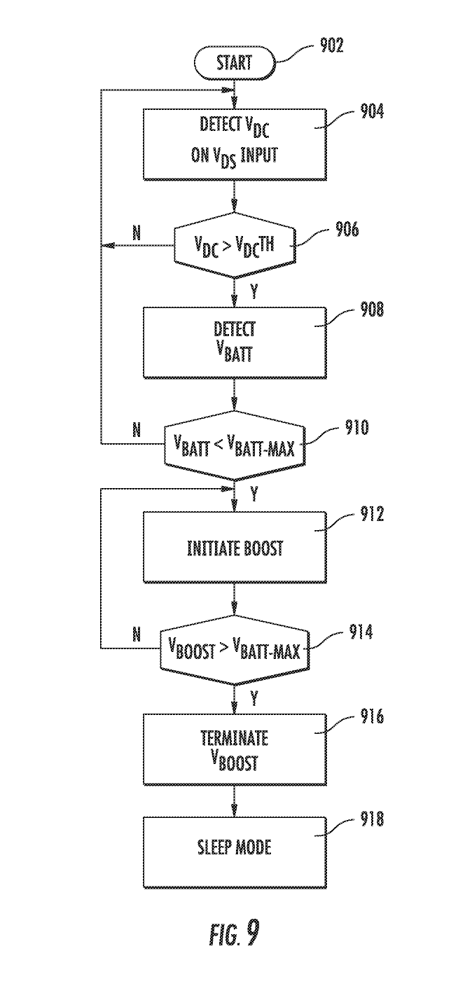

Battery chargers and associated circuitry according to the embodiments of the present disclosure can be embodied in a variety of different electronics devices and systems such as computers, cellular telephones, personal digital assistants, industrial systems, blue tooth devices, media players, automotive dimmable mirrors, energy scavenging devices, radios, transmitters, lighting, solar landscape lighting, signage, water/gas meters, etc. FIG. 6 is a block diagram of an electronic/electric system 600 including battery powered charging circuitry 604. The battery powered charging circuitry 604 provides a battery charger that charges a battery 605 responsive to an input from an energy harvesting device such as a solar cell, but the charging circuitry is powered by the battery being charged such as described with respect to FIGS. 1-5, for charging a battery 605. While the battery powered charging circuitry 604 and battery 605 are illustrated as being located within the electronic/electric circuitry/devices 602, it should be realized that either or both of the components may be located external of the electronic/electric circuitry/devices 602. The electronic/electric circuitry/devices 602 include circuitry for performing various functions required for the given system, such as executing specific software to perform specific calculations or tasks where the electronic system is a computer system. In addition, the electronic/electric system 600 may include one or more input devices 606, such as a keyboard, mouse or touch pad coupled to the electronic circuitry/device 602 to allow an operator to interface with the system. Typically, the electronic/electric system 600 may include one or more output devices 608 coupled to the electronics/electric circuitry/device 602, such output devices typically including a video display such as a LCD display. One or more data storage devices 610 are also typically coupled to the electronic/electric circuitry/device 602 to store data or retrieve data from the needed storage media. Examples of such data storage devices 610 include magnetic disc drives, tape cassettes, compact disc read only (CD ROMS) compact disc (CD R/W), memory and digital video disc (DVD), flash memory drives, and so on.

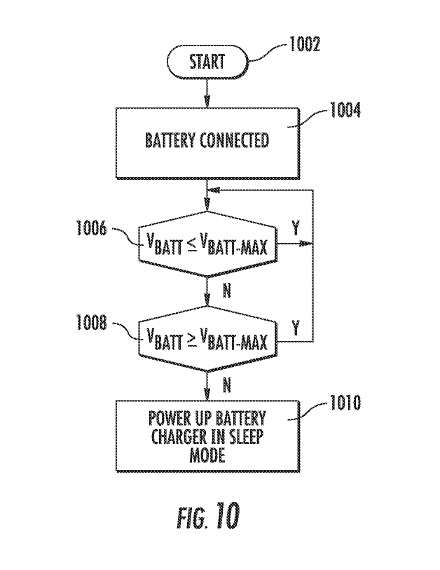

Referring now to FIG. 7, there is illustrated a simplified diagrammatic view of the circuitry required for the synchronous boost. This involves the two transistors 420 and 418 and inductor 406, the transistor 420 labeled Q1 and the transistor 418 labeled Q2. Transistor 420 is operable to be turned on to connect the input node 410 which will be referred to as input node 410 or node 410 for purposes of this discussion, to the reference voltage on node 400. This transistor 420 is an n-channel transistor and the transistor is illustrated with a body diode 702 configured to be reversed biased when a voltage on input node 410 is higher than the voltage at node 400. In this configuration, the transistor 420 will not conduct when turned off except when the voltage on input node 410 falls below the node 400. The transistor 418 is operable to connect node to output node 414 to charge the battery 416. However, when transistor 420 is turned on, transistor 418 is turned off and should be configured to block any current from output node 414 to input node 410.

This is a synchronous boost circuit, but it should be understood that transistor 418 can be replaced by a single diode to provide a non-synchronous boost circuit. However, the disclosed embodiment implements the battery charger on a monolithic IC and, as such, it is difficult to realize a diode that will perform satisfactorily. A bipolar process would be required or even a BiCMOS process. The body diode in the MOS transistor is not fast enough to function in a synchronous boost circuit.

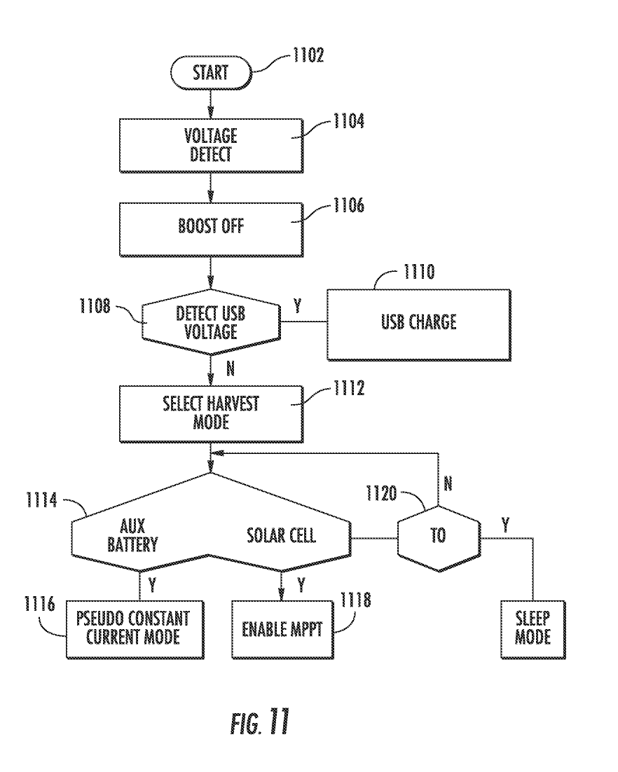

Referring now to FIG. 8, there is illustrated a timing diagram for the operation of the synchronous boost circuit of FIG. 7. Initially, an energy source 706, corresponding to the low voltage harvesting device such as a solar cell 402 of FIGS. 3-5, will provide energy at a voltage lower than that of the battery 416. When transistor 420 turns on, current flows into inductor 406 charging inductor 406. When transistor 420 is turned off and transistor 418 is turned on, the current through transistor 418, I_{Q2} increases to transfer the charge from inductor 406 to the battery. The voltage on the energy source is at an open cell voltage level V_{DC}. This is the open cell voltage. Initially, at a point 802, transistor 418 and transistor 420 are open such that the open cell voltage can be measured. This is for the purpose of protecting the presence of a voltage. This will be described in more detailed hereinbelow with respect to the described flow charts. At point 804, when transistor 420 is turned on, the voltage on input node 410 will be pulled low and then, at point 806, transistor 420 is turned off and transistor 418 turned on to raise the voltage to the voltage boost level, V_{BOOST}. A dotted line is illustrated showing the battery voltage which, at point 806, will begin increasing due to charge being transferred thereto. The level of V_{BOOST} will decrease down until a point 810, when transistor 418 again turns off and transistor 420 again turns on. This will result in a delta charge being added to the battery and the voltage changing slightly. This operation will continue until the battery 416 has been charged. It should be understood that there may be a slight delay provided between turning off transistor 420 and turning on transistor 418 to provide some dead time to prevent conduction through transistor 418 until transistor 420 is completely turned off. This is also the case with respect to turning off transistor 418 and waiting a predetermined amount of dead time before turning on transistor 420.

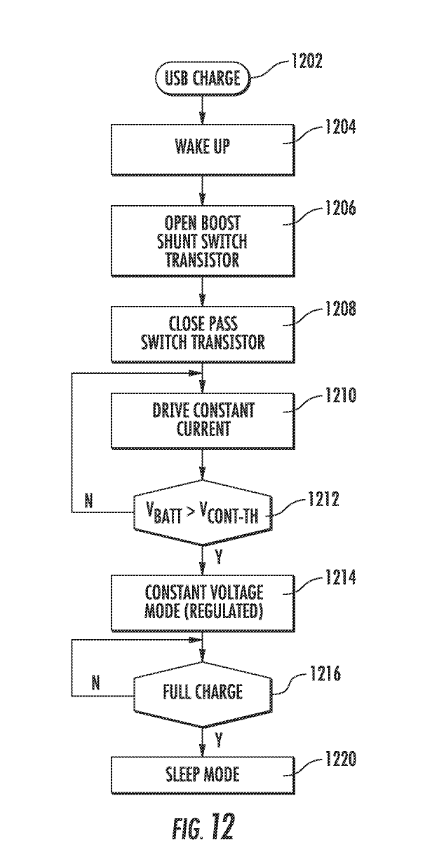

Referring now to FIG. 9, there is illustrated a flow chart for the boost operation. This is initiated at a start block 902 and then the program proceeds to a block 904 to detect an open cell voltage V_{DC} on the input node 410 which is labeled V_{DC}. This flow chart of FIG. 9 is directed to the operation wherein an USB input is not provided and all that is being detected is whether there is a low power harvesting device connected to the V_{DS} node. The program goes through a decision block 906 to determine if the voltage level of V_{DC} is greater than a threshold voltage which is set by the voltage detector 426. The voltage detector 426 is typically a window voltage detector that has a resistor string associated therewith such that it can detect the presence of multiple voltages by comparing the voltage on V_{DS} with multiple references. The voltage detector 426 is illustrated in a simplified diagram, however. If the voltage is less than the threshold, this indicates that there is either no energy source present or the energy output therefrom is below an acceptable charging level. In this case, the program will flow back along an “N” path to the input of function block 904. When the voltage exceeds this threshold, the program flows along a “Y” path to a function block 908 to detect the voltage on the battery, V_{BATT}. If this voltage is less than a maximum charge voltage, the program will go to a charge operation and it will flow back to the input of function block 904. When a charge operation is indicated, the battery being above a safe level or below a full charge level, the program will flow along a “Y” path to a function block 912 from the decision block 910 that determined if the voltage V_{BATT} was at the appropriate level to initiate the boost operation. The program then flows to a decision block 914 to determine if the boost voltage is greater than the battery voltage V_{BATT}. If not, the program flows along an “N” path to a function block 916 to change the duty cycle of the boost operation.

When the boost voltage V_{BOOST} is greater than the voltage V_{BATT} determined at decision block 914 is greater than the V_{BATT-MAX} value, this indicates that the battery is at a full charge level and the program proceeds to a function block 916 to terminate the boost and then to block 918 to enter into sleep mode. Otherwise, the program flows back to the input of function block 912 to continue the boost operation.

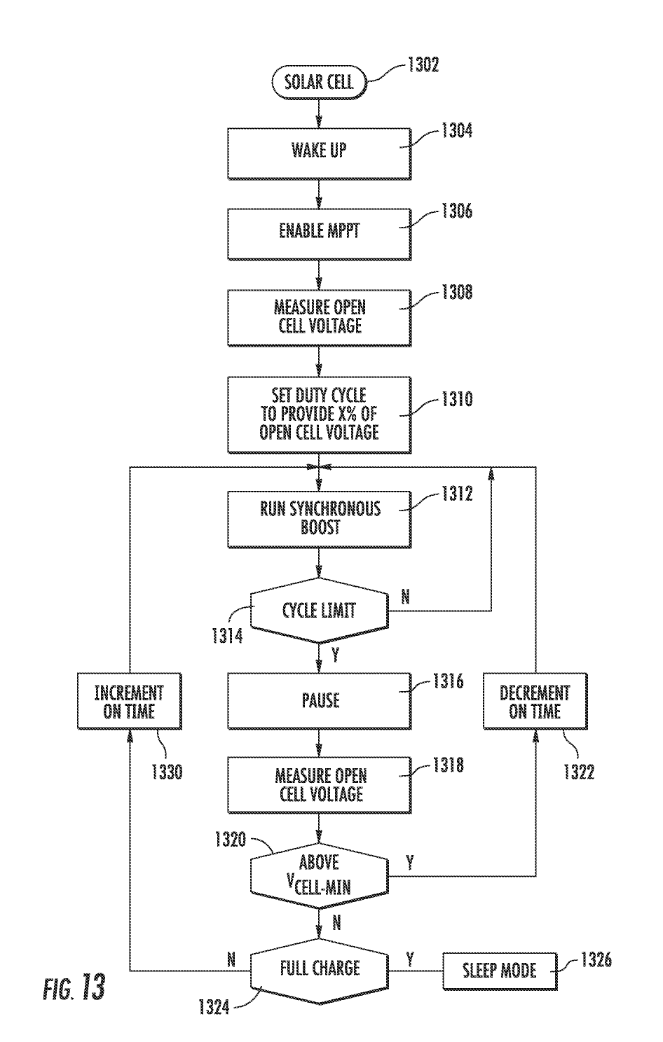

Referring now to FIG. 10, there is illustrated a flow chart for the general operation of the battery charger disclosed herein, primarily directed toward the embodiment of FIG. 5. In the embodiment of FIG. 5, there is provided a provision for the USB external input or an external voltage input wherein the voltage of that input is higher than the battery voltage. As noted hereinabove, such voltage does not require the synchronous boost operation and, therefore, this operation would be terminated and a different charging algorithm would be utilized. If the external voltage were not found, then a detection would be attempted of the low voltage energy harvesting source, either a solar cell, a single AA battery cell or other such low voltage harvesting sources. Of course, the transistor 508 is utilized to disconnect the low energy harvesting sources from the circuit when determining if the external power source is associated therewith. Once a detection is made that an external power source is not present, the transistor 508 can connect the low side of the energy harvesting sources to the reference node 400. It should be noted, however, that the external power could be provided as a separate voltage and there could actually be a separate charging circuit specifically for the external power circuit, thus not requiring the transistor 508.

Referring back to the flow chart of FIG. 10, it is noted that the battery charger IC 412 cannot be powered from the low voltage energy harvesting sources due to the fact, as described hereinabove, that the circuitry thereon is incompatible with the voltage level at the lowest of the energy harvesting sources. Thus, a battery is required to power the V_{CC} input to provide supply voltage to the battery charger 412. When the battery 416 is connected, the controller 422 will go into a power-up reset operation. In this power-up reset operation, a number of control functions are performed, the first of which is to determine if the battery charger can enter an operating mode. The program in the flow chart FIG. 10 determines whether the battery is above a safe value or below a safe value. In decision block 1006, a determination is made as to whether the battery voltage is less than or equal to a minimum battery voltage. For a minimum voltage, the threshold would be in the range of 2.5V to 2.9V range, depending on the chemistry and/or manufacturing of the Lithium-Ion battery. This is facilitated with the charge control circuit 428. This is a comparator and a voltage reference. This charge control circuit 428 is realized with a window comparator for this function requiring a threshold voltage for the low value and a threshold voltage for the high value. Once it has been determined by the charge control circuit 428 that the battery voltage is greater than the minimum voltage, the program flows to a decision block 1008 to determine if it is above a maximum voltage, above 4.2V, for example. If it is not greater than that voltage, it will determine that the battery is within a safe operating range and is capable of being charged. The program will then flow to a function block 1010 to place the charger in a sleep mode. Thus, in this initial power-up operation, the charge control circuit 428 would be the only device that would be operating and, once the tests were passed, then it would be possible to go into sleep mode and the charge control circuit 428 would be turned off in addition to the voltage reference 434. The voltage detector 426 would then be activated in addition to the voltage reference 432. As described hereinabove, the voltage detector 426 has the ability to measure the presence of different voltage levels against different threshold voltages or reference voltages. Thus, when the part is initially powered up, it will operate in multiple and different states, depending upon the particular environment that it operates in. The first state is to determine if the battery that is connected to the part has sufficient power to allow the part to operate in a battery charge mode. If not, the battery charger will be inhibited from operating as such until the battery enters into a safe mode. Once it is determined that the battery can operate in a charge mode, then the controller 422 is placed into sleep mode and certain peripheral circuits such as a voltage detectors, etc., activated in order to monitor for various conditions that allow the battery to be charged, as described hereinbelow.

Referring now to FIG. 11, there is illustrated a flow chart depicting the operation of detecting the presence of an energy source for the purpose of charging, this primarily directed to the embodiment of FIG. 5 with the external USB input. The program is initiated at a start block 1102 and then proceeds to a function block 1104 to detect the voltage, primarily this voltage being the voltage detected on node 502 in FIG. 5. The battery charger 412 at this point in time is in a low power sleep mode with only the charge control circuit 428 and associated voltage references 432 operating. This voltage detector 426, as described hereinabove, has the capability to measure the input voltage on node 502 against multiple and different thresholds and to generate outputs that will change the mode of the battery charge 412 to a charging operation to charge by different methods and different charging algorithms.

The program flows from the function block 1104 to function block 1106 indicating that the boost is initially off. This is necessary to ensure that transistor 420 is not conducting and transistor 418 is not conducting. This basically isolates the node 502. The program then flows to a decision block 1108 to determine if the voltage on the node 502 is a USB voltage. Since the voltage will be higher than the battery voltage, a resistor string will typically be utilized to divide this voltage down to a voltage lower than the battery voltage for purposes of comparing to a comparator for comparing the divided down voltage against a USB reference voltage. If it is determined that the voltage on node 502 is at a level representing a USB input, the program will flow along the “Y” path to a function block 1110 to perform a USB charging algorithm, as will be described hereinbelow. If the voltage is determined not to be present on node 502, the state of the system will make a decision that there is no external voltage applied thereto (if a voltage is present on the node 502 lower than the battery voltage, this will present an error When a lack of a voltage level is detected, the program will flow along a “N” path from the decision block 1108 to a function block 1112 in order to select the harvest mode, i.e., the mode wherein the transistor 508 is placed into a conductive mode and the low voltage side of the energy harvesting sources connected to the reference node 400. Of course, the transistors 420 and 418 are still in an open circuit mode. The program will then flow to a decision block 1114 to determine which energy harvesting device is selected by the switch 506. There are multiple and different reasons to select one low voltage harvesting device over the other. For example, it might be that the solar cell, which is a renewable source, would be selected in lieu of a battery for the first available source. However, there are also reasons to select a battery. If the battery or cell is selected, the program will flow to a function block 1116 to charge the battery 416 from the solar cell 406 with a pseudo constant current mode and, if the solar cell is selected, the program will flow to a function block 1118 to enable the MPPT 424 utilized for charging the solar cell. Until a selection is made, the program will flow along a path to a time out decision block 1120 and back again to the decision block 1114. The reason for this is that selection of either the battery 504 or the solar cell 402 may result in the detection of an insufficient voltage level for the purpose of charging. If this is the case and the time limit in the time-out decision block 1120 is reached, the part will go back into a sleep mode. Alternatively, the part could permanently be attached to the solar cell and the voltage detection circuitry remains attached thereto until a voltage is detected. However, by going into the sleep mode, the voltage detection circuitry (voltage detector 426) will again look for the presence of the external USB voltage and then switch to look for the low power energy harvesting devices.

Referring now to FIG. 12, there is illustrated a flow chart for the USB charging operation, which is initiated at block 1202. In a USB charging operation, one has available a DC voltage that is disposed at a voltage level higher than the battery voltage. Thus, a number of different charging algorithms can be utilized.

Once a USB charge has been initiated, the program will flow to a function block 1204 to wake up the battery charger 412 and place it into a battery charge mode, a mode that will charge from a USB source. The algorithm for a lithium-ion battery will be to initially go to a constant current mode, which basically means connecting the USB source on node 502 through transistor 418, which is placed in a full conduction mode, to connect node 502 directly to the positive terminal of the battery 416. Thus, a constant current will be delivered to the battery. Thereafter, when the battery is proximate in voltage to a full charge mode, the mode will be switched to a voltage controlled mode where the charge control circuit 428 will detect the voltage compared to the reference and control transistor 418 to function as a linear regulator. This is illustrated in the flow chart, wherein, after the part is woken up at block 1204, the program flows to a function block 1206 to ensure that the boost shunt switch, transistor 420, is open and then to a function block 1208 to close the pass-through transistor 418. This will result in a constant current drive mode, as indicated by function block 1210. Then the charge control circuit 428 will compare the voltage to a threshold which is labeled V_{COMT-TH} indicating a set threshold for the constant current mode, above which the part will switch to a constant voltage mode. The constant current mode will be maintained in this state until a decision block 1212 determines that this threshold has exceeded. Once exceeded, the program will flow along the “Y” path to a function block 1214 to place the mode in a constant voltage mode, as a linear regulated mode. The program will then flow to decision block 1216 to maintain the charging mode in the constant voltage mode until a full charge has been obtained. This could be a very quick charge, or, depending on the type of load that may be attached to the battery, this could be maintained in a linear regulated constant voltage mode. Once the voltage is determined to be at a full charge level, the program will flow to a function block 1220 to place the part into sleep mode. It should be understood that, as long as the battery is at full charge, the part will be placed into the sleep mode and the voltage detection circuitry of voltage detector 426 not activated. The charge control circuit 428 will operate as a battery voltage detection circuit to determine if the battery is at a less than full charge level, requiring more charge. Thus, there are two monitoring operations, one for monitoring the condition of the battery for the purpose of determining whether it is in a mode that requires charging and, if so, then the battery charger 412 will be placed in a mode to determine if there is sufficient energy to charge the battery. Thus, the detection operation will go from detection of the battery to detection of the harvesting sources all while the controller 422 is maintained in a low current operating mode.

Referring now to FIG. 13, there is illustrated a flow chart depicting the operation of charging the part from the solar cell, which is selected as the low voltage energy harvesting source, which is initiated at a start block 1302 and then proceeds to function block 1304 to wake up the controller 422. The program then flows to a function block 1306 to enable the MPPT 424. The MPPT 424 is device to modify the electrical operating point of the solar cell 402 at which maximum power can be generated. Since the amount of electrical power generated by any photovoltaic system is a function of solar irradiance (solar energy irradiated area of the solar cell's surface) and other conditions such as temperature and cloud cover, it is desirable to determine the current and voltage at which the solar cell/module generates the maximum power, i.e., the maximum power point. However, the maximum power point is not known in advance and must be determined. There are many different MPPT algorithms that can be utilized, some requiring complex circuitry. One MPPT rhythm is the “perturb and observe” method during which the operating voltage or current of the solar cell is modified until maximum power is obtained. This is an iterative procedure. There is the incremental conductance procedure or technique that takes advantage of the fact that the slope of the power-voltage curve is zero at the maximum power point and the slope of the power-voltage curve is positive at the left of the MPP and negative at the right of the MPP. There are also many other techniques. For the present disclosed embodiment, the technique that is utilized is to measure the open cell voltage at the initiation of the boost operation before extracting charge threrefrom and, during the boost operation, maintaining the level above an arbitrary value, which is 76% in one example. By ensuring that the energy extracted from the solar cell 402 does not drop the voltage during boost below this set value of, for example, 76%, this results in a more efficient energy transfer operation from a solar cell, depending upon the irradiance of the cell.

The first step is illustrated at a function block 1308 wherein the open cell voltage is measured. This is facilitated by opening both switches at both of the transistor 420 and 418. Once an open cell voltage is determined, then a duty cycle is set to provide a percentage of X % to the open cell voltage. This will initially be a default value which could be set in some type of look-up table that sets a duty cycle for a particular open cell voltage. Alternatively, a fixed voltage value could be set at the initiation of the charging element. This is illustrated in function block 1310. The program then flows to a function block 1312 to initiate the synchronous boost operation is initiated at this particular duty cycle. The transistor 420 will conduct initially with transistor 418 open to charge up the inductor 406 for a predetermined amount of time, the goal of which is to set this time to a duration that will not pull the open cell voltage of the solar cell 402 below the X % level. The program then flows to a function block 1314 to determine when the open cell voltage should again be examined. This could be every cycle or it could be after a plurality of cycles. The synchronous boost continues for one or more cycles until another detection of the open cell voltage is necessary. This will cause the program to flow along a “Y” path to a function block 1316 to pause the synchronous boost operation and then it flows to function block 1318 to again measure the open cell voltage. If the open cell voltage is above the minimum voltage, then a decision block 1320 will direct the flow along a “Y” path to function block 1320 in order to decrement the on-time of transistor 420 and then back to the input of function block to continue the synchronous boost operation. If it is not above the minimum open cell voltage level, i.e., X % level, it then flows along an “N” path to function block 1324 to determine if a full charge is present, at which time it will flow to a sleep mode function block 1326. However, if the battery is not at a full charge level, then the program flows along the “N” path to function block 1330 to increment the on-time of transistor 420 and then back to the input of function block 1312 to run the synchronous boost operation. This iterative procedure will continue with the goal of setting the open cell voltage at V_{CELL-MIN}, which is the X % of the open cell voltage. As noted hereinabove, a value of around 76% is desirable as one goal. Other values could be utilized. Further, other techniques can be utilized that would actually measure the actual power of the solar cell output to determine the maximum voltage. Of course, this would require some type of current sensor. This current sensor would be facilitated in the return leg of transistor 420 between transistor 420 and the reference node 400. This is not shown, as that particular MPPT algorithm is not illustrated.

Referring now to FIG. 14, there is illustrated a flow chart for the charging operation from the low voltage energy source wherein the battery is selected, which is initiated at function block 1402. The program proceeds to a function block 1406 to wake up the part and place it into the auxiliary battery charging mode, this being a mode that charges from a known fixed energy source such as a battery. The program then flows to a function block 1408 to measure the battery voltage of the auxiliary battery and then the duty cycle of the synchronous boost set at a function block 1410, it being understood that the voltage of the auxiliary battery will vary only a small amount. Of course, as it discharges, the voltage will change and the duty cycle of the synchronous will be changed in accordance with a look-up table or the such in the controller 422. The program then flows to a function block 1412 to determine if a full charge has been present and, if not, the synchronous boost is maintained. Once a full charge is achieved, the program flows to a sleep mode block 1414.

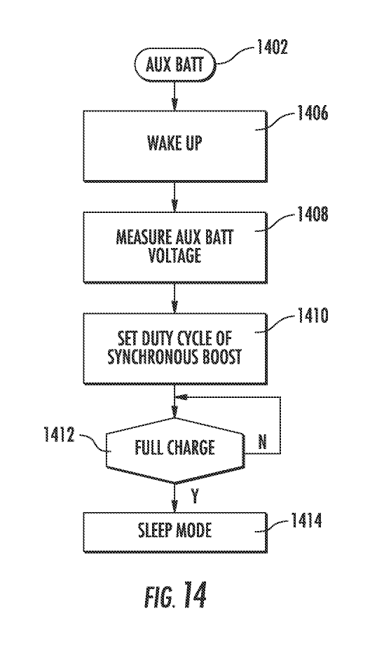

Referring now to FIG. 15, it is illustrated a diagrammatic view of one realization for the battery on an integrated circuit. An integrated circuit is illustrated as a monolithic chip 1502 in which the controller 422 and the transistors 418 and 420 are fabricated with a common CMOS process. The other circuitry is not illustrated that is part of the battery charger 412, but it should be understood that that is also fabricated on the same chip 1502. The purpose of this illustration is to show that the transistors 418 and 420 are fabricated on a chip and are governed by the breakdown voltages of the associated oxides and the such. Therefore, a voltage on input node 410 being at a level much higher than the battery voltage must be maintained at a voltage lower than the breakdown voltage of the oxide on transistors 418 and 420, as they could be exposed to both a high voltage output from the inductor 406 (not shown in FIG. 15) or from an external voltage such as a USB voltage.

FIG. 16 illustrates an alternate embodiment wherein a monolithic chip 1602 is provided on which the controller 422 and all the remaining circuitry with the exception of the transistors 418 and 420 are fabricated on the monolithic circuitry. The purpose of this is that it may be desirable to have a higher voltage level on the input node 410, which voltage is not compatible with standard CMOS processing. Further, higher current levels may be required which could not be accommodated on the standard chip. Further, it may be desirable to have a more universal IC that could handle the multiple currents. This can be facilitated by utilizing a monolithic chip 1602 with all of the circuitry except for the transistors 418 and 420 and then providing the transistors 418 and 420 on a separate chip utilizing a separate process in the same package. This is typically referred to as a hybrid packaged device.

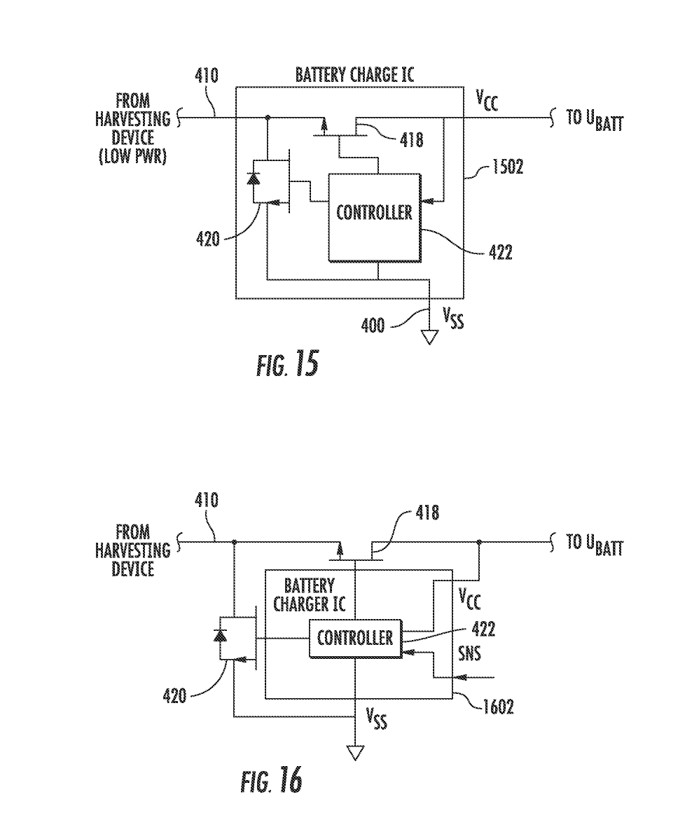

Referring now to FIG. 17, there is illustrated a diagrammatic of an application for the battery charger 412 disclosed hereinabove. In a hand-held unit or a self-enclosed unit 1702, a CPU 1704 is provided which carries out certain application specific functions. This CPU 1704 could be any functional device powered by a battery. This is powered by a rechargeable battery 1706, wherein the battery is basically the source for the operation of the CPU 1704. The CPU could drive displays, could be controlled by a keyboard, etc. However, in this embodiment, only the CPU is illustrated as being powered by a battery 1706. The battery 1706 also is charged from the battery charger IC 412, which both charges the battery 1706 and receives power therefrom for the operation thereof. In this embodiment, only a solar cell 1708, a low energy harvesting device, is provided which is connected to the battery charger IC 412 via an inductor 1710. This solar cell is illustrated as being disposed “within” the self-enclosed unit 1702, but it would be connected to the unit on the outside or near the unit in close association therewith. Therefore, the normal CPU operation will continue independent of the charging operation. The entire charging operation is facilitated via the battery charger IC 412. The only component that is required is inductor 1710 and the solar cell 1708. This can be a self-contained unit which will continuously charge the battery, if necessary.

Referring now to FIG. 18, there is illustrated an alternate embodiment of that of FIG. 17 for a self-contained hand-held fixed unit 1802. In this embodiment, there is provided a single chip CPU 1804. This CPU 1804 on a single chip also includes on the same chip a battery charging section 1806, which battery charging section 1806 contains all the functionality of the battery charger 412. This is basically a CPU/charging IC. All that is required is to have a battery 1806 associated therewith for providing both power to the CPU via a power line 1811 and power to the battery charging circuit via a power line 1813. The number lines required for interfacing the battery could be a single line or multiple lines, depending on the operation. However, the battery charging operation is powered by the battery, as well as a functional operation of the CPU 1804. The device would have, again, a solar cell 1810 and an inductor 1812 in accordance with the embodiments described hereinabove with respect to FIGS. 2-5. The solar cell 1810 could be replaced by any type of energy harvesting device or it could utilize multiple energy harvesting devices. Additionally, although not shown, an external charging voltage could be applied to the battery charging section to charge the battery from an external source such as a USB source.

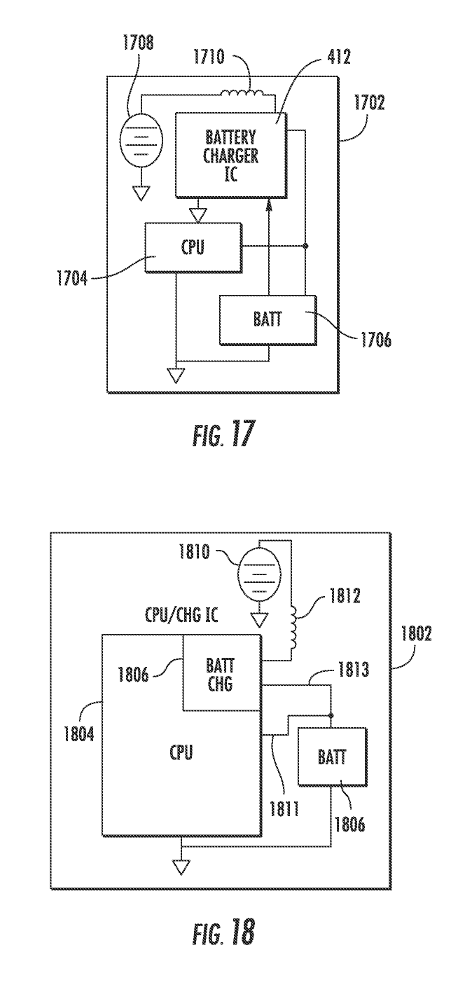

Referring now to FIG. 19, there is illustrated another embodiment illustrating a self-contained power unit which basically is similar to that in FIG. 18 having a housing 1902 in which is contained some type of control device 1904. For example, the control device could be an electro chromic mirror on an automobile. The operation of the electro chromic mirror is a controlled operation that requires a battery 1906 for the operation thereof. This enables the system to be a stand-alone system that does not require connection to the car battery required the wire connection to the such. Thus, the control device 1904 requiring battery 1906 will have an associated battery charger IC 1907 associated therewith for both powering the charging the battery 1906 and receiving power therefrom and interfacing with the a solar cell 1908 via an inductor 1910. By being self-contained with the solar cell placed on the outside, a main battery of the system is not required.

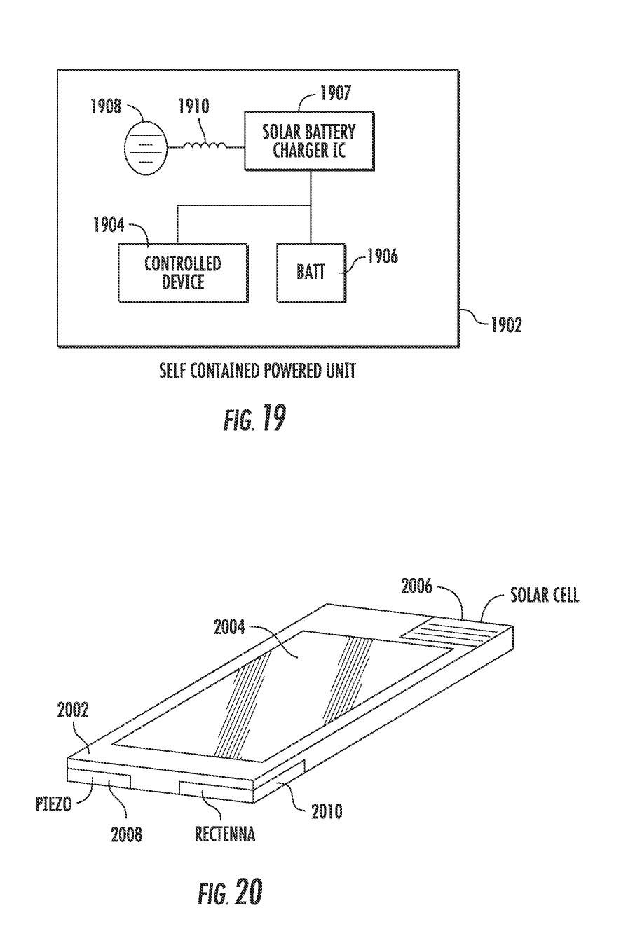

Referring now to FIG. 20, there is illustrated a perspective view of a device having multiple energy harvesting devices associated therewith. The device is contained within a housing 2002 and is similar to the device in FIG. 19 in that the control device has all of the intelligence associated within the device, such as a smart phone or the such, and having the display 2004 associated therewith. Within the device is contained the battery and the solar battery charging IC 1907. Disposed in association therewith is a solar cell 2006, a piezoelectric device 2008 and possible an RF harvesting device 2010, which is referred to as an “rectenna.” All of these devices can generate energy from the environment and they can be selected by the battery charger IC 1907 for harvesting energy therefrom.

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A battery charger integrated circuit, comprising:
a first input for receiving a charging input from a low voltage energy harvesting device;
a first output for providing a charging current to a battery;
a controller for controlling a charging operation to charge the battery through the first output responsive to the charging input from the energy harvesting device, the controller operating at an operating voltage level, which operating voltage level is above the minimum voltage output by the low voltage energy harvesting device; and
wherein the battery charging integrated circuit is powered by the battery connected to the first output.

2. The battery charger integrated circuit of claim 1, further including an external power source connection for connecting an external power source to the battery charger integrated circuit for charging the battery connected to the first output.

3. The battery charger integrated circuit of claim 1, wherein the controller is implemented using a CMOS semiconductor process yielding a semiconductor with 2.5V threshold voltage devices formed thereon.

4. The battery charger integrated circuit of claim 1, wherein the first input may further receive a second charging input from a second battery.

5. The battery charger integrated circuit of claim 1, wherein the controller further comprises maximum power point transfer circuitry for monitoring the input power and providing a first control signal responsive thereto.

6. The battery charger integrated circuit of claim 5, wherein the controller further comprises a voltage detector for detecting the input voltage level and generating a second control signal responsive thereto.

7. The battery charger integrated circuit of claim 6, wherein the controller further comprises a charge control circuit for detecting a voltage level of the battery connected to the first output and generating a third control signal responsive thereto and placing the battery charger integrated circuit in one of a sleep mode of operation or an active mode of operation responsive to the first, second and third control signals.

8. A battery charger for charging a battery, comprising:
an input for coupling to a low voltage energy harvesting device capable of operating at a voltage lower than the battery;
a battery charge core operating in a plurality of charging modes to receive the output of the coupled energy harvesting device and causing charge to be transferred therefrom to the battery; and
wherein the battery charge core is powered from the battery at an operating voltage that is above the lowest possible output voltage of the energy harvesting device.

9. The battery charger of claim 8. wherein the battery core includes a battery voltage detect circuit that monitors the voltage of the battery against at least one or more voltage references and wherein at least one of the modes is a battery monitoring mode that compares the battery voltage with one of the at least one or more voltage references with the battery voltage detect circuit and inhibits operation of the battery core to transfer charge to the battery when it is detected that the battery voltage is outside of a safe charging range.

10. The battery charger of claim 9, wherein at least one of the modes is a low power operating mode for the battery core and wherein detection of the battery voltage being outside of a safe charging range causes activation of such low operating power mode in such a manner that the battery voltage detect circuit remains in a powered mode from the battery.

11. The battery charger of claim 8, wherein the battery core includes an input voltage detect circuit that monitors the voltage of the input against at least one or more voltage references and wherein at least one of the modes is an input voltage monitoring mode that compares the input voltage with one of the at least one or more voltage references with the input voltage detect circuit and initiates operation of the battery core to transfer charge to the battery when the presence of an input voltage is detected.

12. The battery charger of claim 11, wherein at least one of the modes is a low power operating mode for the battery core and wherein detection of either no voltage or of a voltage of insufficient level for battery charging by the input voltage detect circuit causes activation of such low power mode in such a manner that the input voltage detect circuit remains in a powered mode from the battery.

13. A method for charging a battery from a low power energy harvesting device, which low power energy harvesting device is capable of outputting a voltage lower than the voltage of the battery, comprising the steps of:
receiving power from the low power energy harvesting device;
receiving operating power from the battery when connected; and
transferring charge from the low power energy harvesting device to the battery with a battery charge controller powered by the received operating power;
wherein the output of the low power energy harvesting is insufficient to power any portion of the operation of transferring charge to the battery by the battery charge controller.

14. The method of claim 13, wherein the battery controller has a start up mode and further comprising the step of the battery controller entering the start up mode when the battery is connected, and wherein no operations of the battery controller are possible before the battery is connected.

15. The method of claim 14, and further comprising the steps of:
detecting an unsafe voltage level of the battery unsuitable for charging thereof; and
forcing the battery controller into a low power mode of operation until the step of detecting determines that the battery voltage is at a safe operating level, after which the battery controller operates in a full power mode drawing all of its power from the battery.

16. The method of claim 13. and further comprising the steps of:
receiving an external voltage input signal generated by an external power source and having a voltage above the voltage level of the battery;
detecting the presence of the external voltage input signal; and
transferring charge from the external voltage source to the battery with the battery charge controller with a charging process different that a charging process for transferring charge from the low voltage energy harvesting device.

17. The method of claim 16, wherein the battery controller operates in a plurality of operating modes, one of which is a low power mode for operating in at least a voltage detecting mode to detect the voltage level of the external voltage source and the low voltage energy harvesting device, and the battery controller operating in a full power mode in response to detection of a voltage level to transfer charge from the either the low voltage energy harvesting device or the external power source to the battery.

18. The method of claim 17, wherein the battery controller transfers charge from the external power source if a voltage signal therefrom is detected in priority over the low voltage energy harvesting device and, if a voltage signal from the external power source is not detected, then transferring charge from the low voltage energy harvesting device if detected.

19. The method of claim 16, wherein the step of transferring charge from the external voltage source comprises charging the battery therefrom by the battery controller with a charging process for charging selected from_the group consisting of a constant voltage process or a constant current process.

20. A self contained powered device, comprising:
a housing;
a functional device powered by a battery disposed in the housing, the functional device performing a predetermined function;
a rechargeable battery disposed in the housing;
at least one low voltage energy harvesting device disposed in close association with the housing; and
a battery charger powered by the battery and operable to transfer charge from the low voltage energy harvesting device to the battery from a voltage level of the low voltage energy harvesting device that is lower than the voltage level of the battery.

21. The powered device of claim 20, wherein the low voltage energy harvesting device provides discontinuous power.

22. The powered device of claim 21, wherein the low voltage energy harvesting device is a solar cell.

23. The powered device of claim 21, wherein the battery charger operates in a full power mode to transfer charge and in a low power mode when either the battery is at a full charge level or the power output by the low voltage energy harvesting device is insufficient to charge the battery.

24. The powered device of claim 20, wherein the battery charger includes:
a power converter for converting the voltage from the low voltage energy harvesting device to a voltage level capable of charging the battery; and
a controller for controlling the operation of the power converter to transfer charge to the battery until the battery is at a full charge level.

25. The powered device of claim 24, and further comprising an interface for interfacing with an external power source with an operating voltage higher than the voltage of the battery and, wherein the battery charger includes:
an input voltage detector for detecting the voltage on the low voltage power energy harvesting device and the interface;
the controller operable to select one of the external power source or the low power energy harvesting device for input to the power converter; and
the power converter having associated therewith a plurality of battery charging process, one for converting the voltage of selected one of the low voltage energy harvesting device and external power source to a voltage capable of charging the battery until the controller determines the battery is at a full charge level.

26. A monolithic integrated circuit voltage boost battery charger for charging a rechargeable storage element, comprising:
a storage element input for interfacing with a voltage terminal of the storage element;
an external power source input for interfacing with an external power source, wherein the external power source can operate at a voltage level that is lower than the voltage level of the storage element;
a power converter including a voltage boost circuit for boosting the voltage level on the external power source input that is higher than the voltage level of the storage element;
a charge control section controlling the power converter to maintain the boosted voltage at a level sufficient to charge the storage element until the storage element is at a full charge level; and
the power converter and charge control section powered from the storage element for all operations thereof.

27. The integrated circuit of claim 26, wherein the external power source is a low voltage energy harvesting device selected from the group consisting of a solar cell and a piezoelectric sensor.

28. The integrated circuit of claim 26, wherein the charge control section includes sensing subsections for interfacing each with one of a plurality of sense inputs for sensing parameters external to the integrated circuit and a controller subsection for interfacing with the power converter and the sensing subsections to control battery charging of the storage element, and wherein the charge control section operates in multiple power modes to consume different levels of operating power from the storage element, one of which comprises a low power mode wherein at least one or more of the subsections is placed in a less than full power mode.

29. The integrated circuit of claim 28, wherein the power mode of the controller subsection is a function of the state of the sensing subsections and the sensed parameters.

30. The integrated circuit of claim 29, wherein one of the sensing subsections comprises a storage element voltage detector to determine if the voltage level on the storage element input meets certain criteria.

31. The integrated circuit of claim 30, wherein the controller subsection is placed in a low power mode if the storage element voltage detector determines the storage element is in a state that is not conducive to transfer of charge thereto, but operating power to the charge control section in the low voltage mode of operation is received from the storage element.
